(19) United States
(12) Patent Application Publication
(10) Pub. No.: US 2008/0263598 A1
(43) Pub. Date: Oct. 23, 2008

(54) Optimally Selecting Tv Programs

(75) Inventors: Wilhelmus Franciscus Johannes Vergaegh, Eindhoven (NL); Johannes Henricus Maria Korst, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,885

(22) PCT Filed: Nov. 6, 2006
(86) PCT No.: PCT/IB2006/054125

§ 371 Date: May 7, 2008

Related U.S. Application Data
(60) Provisional application No. 60/735,926, filed on Nov. 10, 2005.

(51) Int. Cl. G06F 3/00; H04N 5/76

(52) U.S. Cl. 725/46; 725/58

(57) ABSTRACT

A system (400), apparatus (300), and method are provided to select a best set of TV programs for reception and recording by at least one tuner said TV programs being broadcast during a given time period [b, e] having a beginning time b and an ending time e. Only entire TV programs are considered and for each TV program a user preference value is provided for its reception and recording. A minimum-cost network algorithm is used that solves the selection and viewing problem to optimality (guaranteed).

The present invention relates to a system, apparatus and method that is guaranteed to make optimal selections of TV programs to be recorded using a limited number of tuners during a given time interval.

Personal video recorders (PVRS) are available to record TV programs, either on hard disk or on DVD. Programming these PVRs is usually accomplished using an electronic program guide (EPG), by simply clicking on the programs to be recorded. Additionally, a recommender may be available that can predict, for an upcoming TV program, how much a viewer will like it.

With the increasingly available television channels via terrestrial, satellite, or cable connections, the task for the viewer to select TV programs to view and record is rapidly becoming too large to be handled manually. With the advent of digital television, the number of channels, and hence the number of options, to choose from is becoming even larger. Therefore, the viewer is no longer able to overview all available programming content and it becomes more likely that the viewer will miss TV programs that would be of interest to the viewer.

Because of the large number of TV programs available each week, printed program guides are cumbersome and electronic program guides (EPGs) have been developed as a solution to this problem. EPGs present the available TV programs for a number of channels on a TV screen. However, only a limited number of programs can be shown at one time on the TV screen, i.e., the number of channels and the length of the time interval of the portion shown on the screen are very limited. This results from the poor resolution of a TV screen for presentation of this kind of textual information. And, even if the resolution were high enough, the task of selecting from the very large amount of available TV content would overwhelm the average viewer.

In order ameliorate the viewer's problem of what TV programs to select and when to watch them, i.e., the problem of developing a viewer-specific viewing schedule, EPGs offer an option of searching (filtering) by keyword(s). In this way EPGs reduce the number of TV programs to be screened and selected by the viewer to a manageable number. Another way for the viewer to cull a plurality of uninteresting-to-the-viewer TV programs is through the use of recommender systems based on artificial intelligence (AI) technology. These AI recommender systems maintain a preference profile of the viewer, indicating what the viewer likes and dislikes, and employ this profile to score each newly offered program as to what extent the viewer will like the newly offered TV program. Then, the programs scoring in excess of a pre-determined viewer-specific tolerance are highlighted in an EPG or the viewer is provided a list of these programs. A problem with these solutions, however, is that they do not take into account whether or not programs overlap in time, so it remains for the viewer to compile a viewer-specific schedule of top-scoring TV programs to watch during, e.g., an evening. In other words, whereas filters and recommenders come up with a list of individual programs, such a list is an incomplete solution to a viewer's problem of creating a schedule of programs to watch.

A similar situation exists for recording TV programs.

A solution is needed for efficient selection of TV programs for a given time interval that maximizes predetermined viewer preferences when the viewer has only a finite number N≧1 of tuners available with which to record selected TV programs.

The system, apparatus, and method of the present invention provide an efficient algorithm that is guaranteed to make optimal selections of TV programs with a limited number of tuners, i.e., that maximizes a sum of the preference values of the selected TV programs. It is assumed that these preferences are known to, e.g., a recommender that provides a first filtering available TV programs before an optimal selection is made using the present invention.

Given a time interval in which a viewer wants to select TV programs, all TV programs that fall in this interval are first collected and preference values for each collected TV program are obtained. Second, the begin and end time points of each TV program are determined. Third, a source and a sink node are created corresponding the limits of the given time interval and the pairs of begin and end time points for each TV program. A graph G from the source through the successive begin and end time points to the sink is drawn, i.e., a time line from the source node through each successive begin and end time point, wherein each edge has a cost of ‘0’. Furthermore, for each TV program an edge is drawn between the node corresponding to its begin time and the node corresponding to its end time and this edge is given a ‘cost’ equal to the negated value of the TV program (viewer preference value). Key in the present invention is the graph G comprising a central time line, from and to which the TV program edges run.

Given this directed graph G, a minimum-cost network algorithm is applied thereto that determines the set of TV program, for a given time interval, that provides the maximum viewer satisfaction, i.e., maximizes the total viewer preference values for the set of TV programs. The selected set is guaranteed to be optimal and the algorithm is guaranteed to run in polynomial time.

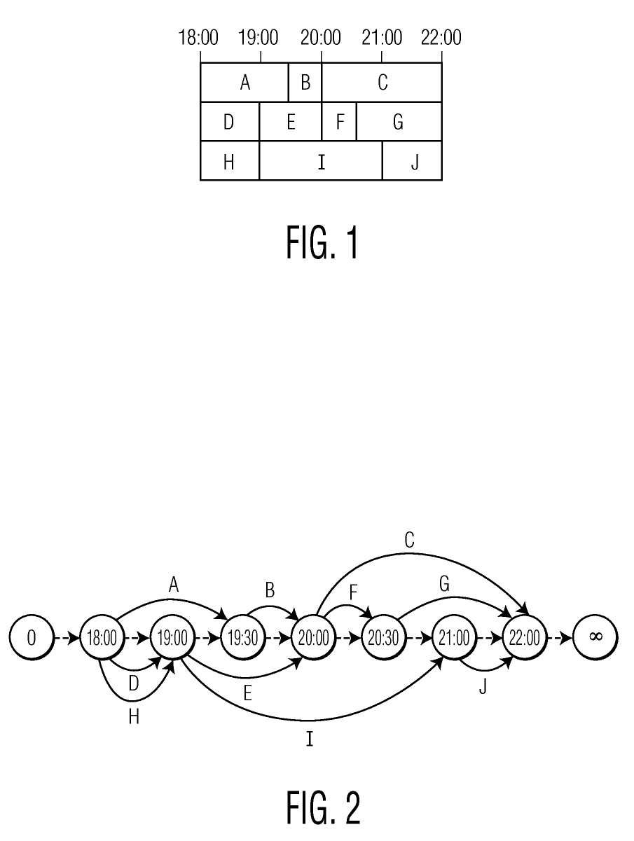

FIG. 1 illustrates a number of TV programs offered over time t;

FIG. 2 illustrates a graph for the TV programs of FIG. 1;

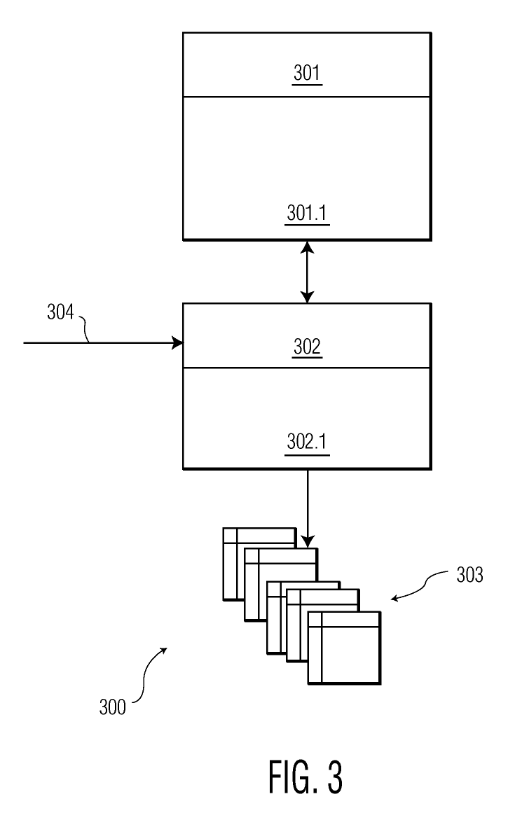

FIG. 3 illustrates an apparatus for performing the method according to the present invention; and

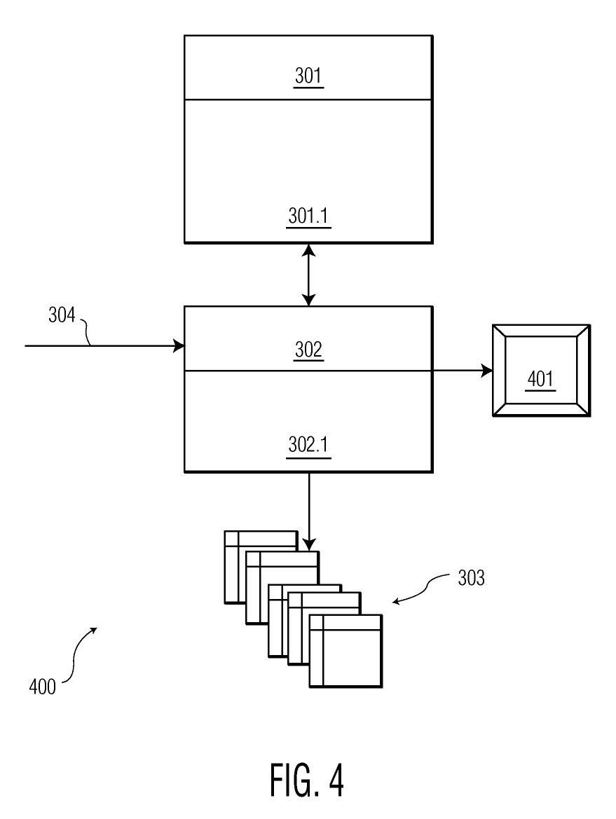

FIG. 4 illustrate a system for receiving, recording a displaying a set of TV programs according to the present invention.

The system, apparatus, and method of the present invention provide a way of determining an optimal TV experience for a viewer for a given time interval, the experience comprising watching as well as recording preferred TV programs using a plurality of tuners.

The system, apparatus, and method of the present invention provide a mathematical formulation and solution strategy for obtaining an optimal solution to a viewer's TV program scheduling problem. The scope of the system, apparatus, and method of the present invention includes the problem of what TV programs to select for watching or recording with a given number of available tuners based on a pre-determined viewer preference for all available TV programs being broadcast in given time period.

A first preferred embodiment provides a simplified problem setting and a second preferred embodiment extends the simplified problem setting to include more factors and to elaborate the algorithms developed for the simplified problem, in order to solve more complex problem settings.

In a preferred embodiment of the system, apparatus, and method of the present invention, several assumptions are first made:
1. a preference value or score is provided for each of a plurality of candidate TV programs, indicating how much a viewer prefers the candidate TV program;
2. each preference score is given explicitly by the viewer or by a recommender tool;
3. the total preference score for a number of TV programs being selected is given by a linear sum of the provided preference scores of the individual TV programs; and
4. TV programs that are selected for watching are assumed to be watched at the very moment they are broadcast; if a TV program is watched later, it is simply assumed to be recorded during its broadcast.

In formulating a model, a preferred embodiment of the system, apparatus, and method of the present invention takes into account a plurality of factors, including that only complete TV programs are viewed and recorded.

Each model formulation embodiments is translated into a minimum-cost network flow problem. Since minimum-cost network flow problems can be solved in polynomial time, the corresponding TV program selection problem can be solved efficiently.

Live Watching

In a first live-watching embodiment, the TV programs selected for watching are to be watched live, not time-shifted (recorded for later viewing). In this case, there is no additional problem of when to watch the selected TV programs as it is directly given by the time of broadcast. Further, the first embodiment is only for complete TV programs for watching using one tuner.

The second embodiment is provided as an extension to the basic live-watching embodiment that uses multiple tuners, in order to also select TV programs for recording.

The first embodiment selects complete TV programs using one tuner. The problem of selecting complete TV programs is defined as follows.

Definition 1 (Program selection problem (SSP)). A set S of TV programs s is given and for each TV program s a begin time bₛ and end time eₛ is also specified. Furthermore, for each TV program a value vₛ>0 is given, which reflects the total value if this TV program is watched (completely). The question is to determine a subset S′⊂S such that the TV programs in S do not conflict in time, i.e.,

bₛ>eₜVbₜ>eₛ

for all s, tεS′, s≠t, and such that the total value of this subset, given by

$${\sum }_{s ∈ {S}^{′}} {v}_{s}$$

is maximized.

The value vₛ of a program can be given by the viewer explicitly, or it can be estimated using a recommender. Considering the recommender score pₛ of a program s as a preference density, the total value is given by vₛ=pₛ(eₛ−bₛ). Maximizing the total value over a number of TV programs in a certain time interval then corresponds to maximizing the average preference density.

The TV program selection problem can be formulated as a minimum-cost flow problem as follows. The set V of nodes of a network G is given by a source node and a sink node, and a node for each begin or end time of a TV program. So,

$$V = \{ 0 , ∞ \} ⋃ {⋃}_{s ∈ S} \{ {b}_{s} , {e}_{s} \} ,$$

where the node 0 represents the source and ∞ represents the sink. Denoting the nodes (i.e., times) in V by t₁, . . . , tₙ the n distinct times can then be arranged in increasing order. Here, it is assumed that all times are larger than the source time t₁=0, and smaller than the sink time tₙ=∞.

The set E of edges consists of two parts. First, there is an edge on a timeline from source to since that includes the node edge (tᵢ, tᵢ₊₁) for all i=1, . . . , n−1, having zero cost, by definition. Secondly, for each TV program sεS, an edge (bₛ, eₛ) is added, with cost−v_{S}. All edges are assumed to have capacity one.

For an example of the graph construction, consider the set of programs as indicated in FIG. 1, covering programs A, B, . . . , J in a time interval from 18:00 h to 22:00 h. The corresponding set V of time points is given by

F={0, 18:00, 19:00, 19:30, 20:00, 20:30, 21:00, 22:00, ∞},

and the set of edges is as given in FIG. 2.

Now, determining a non-overlapping subset S′ with maximal value corresponds to finding a flow of one in G from the source to the sink with minimum cost. If in this minimum-cost flow an edge corresponding to a TV program carries a flow of one, then this program can be included in S′; otherwise not. Hence, the problem can be solved by means of a minimum-cost flow algorithm. In other words, SSP can be solved efficiently.

As in the above formulation all capacities are one, the minimum-cost flow problem reduces to a shortest-path problem (from source to sink), where the (negative) costs are used as edge lengths.

The min-cost flow problem: Given a directed graph G=(V, E). Let there be a cost cᵢⱼ and capacity uᵢⱼ=1, associated with each edge ij in E, and a demand (supply) bᵥ associated with each node v in V. The problem is to find a flow of minimum cost which satisfies the supply/demand constraints for each node,

$${b}_{v} = {\sum }_{j} {f}_{vj} - {\sum }_{j} {f}_{jv}$$

and the edge constraints,

0≦fᵢⱼ≦uᵢⱼ.

The cost of the flow is defined as

$${\sum }_{ij ∈ E} {c}_{ij} {f}_{ij} .$$

In the present invention, the capacity of each edge is 1, by definition. Furthermore, b₁=−1, bₙ=1, and bᵢ=0 for i=2, . . . , n−1.

A second embodiment selects complete programs using multiple tuners. Multiple TV programs are received in parallel whenever more than one tuner is available, and the additionally selected TV programs are recorded. The problem is also relevant in a two-stage TV programming approach, where one first determines what TV programs to receive, which are then stored in a persistent memory, and then determines a TV schedule from all content that has been recorded in the persistent memory.

Definition 2 (Multi-tuner program selection problem (MSSP)). Given is a set S of TV programs for each program s a begin time bₛ, an end time eₛ, and a value vₛ are given. Furthermore, a pre-determined number M of tuners is also given. The question is to determine a subset S′⊂S such that at all times at most M TV programs have been selected, i.e., for all times x

|{sεS^{l}|bₛ≦x≦eₛ}|≦M

and such that the total value of this subset, given by

$${\sum }_{s ∈ {S}^{′}} {v}_{s}$$

is maximized.

MSSP is solved in a similar way as SSP, using an equivalent network flow transformation as presented above. The only difference is that for MSSP the capacities of the edges (tᵢ, tᵢ₊₁) are changed into M to reflect the availability of M tuners; the capacity of the TV program edges remains one, as it is not desirable for a program to be received multiple times.

Next, a minimum-cost flow of M from source to sink is determined, and again each TV program for which the corresponding edge in the graph carries a flow (of one) in this found minimum-cost flow solution is included in S.

Referring now to FIG. 3, an apparatus (300) is shown for selecting a set S (301.1) from a memory module (301) storing a given set of N≧1 TV programs s, each having a begin time bₛ, an end time eₛ, and a viewer-preference value νₛ, the latter being provided by the viewer or a recommender. The apparatus further comprises a processor module (302) that executes or itself further comprises a minimum cost network algorithm module for selecting an optimal set S′⊂S to be received and possibly recorded by M≧1 tuners (303).

Referring now to FIG. 4, a system (400) comprising the apparatus of FIG. 3 to select an optimal set of TV programs for a given time interval and given viewer preferences, and a TV set wherein an incoming broadcast signal (304) is scanned for TV programs selected by the apparatus of FIG. 3 (300) and selected TV programs are recorded by the tuners (303) and displayed on the TV (401) all being controlled/executed by processor (302).

While the preferred embodiments of the present invention have been illustrated and described, it will be understood by those skilled in the art, the system, apparatus and method for selecting a best set of TV programs based on maximizing viewer satisfaction expressed as a function of viewer preferences, as described herein, are illustrative and various changes and modifications may be made and equivalents may be substituted for elements thereof without departing from the true scope of the present invention. In addition, many modifications may be made to adapt the teachings of the present invention to a particular situation, e.g., various optimization algorithms, without departing from its central scope. Therefore, it is intended that the present invention not be limited to the particular embodiments disclosed as the best mode contemplated for carrying out the present invention, but that the present invention include all embodiments falling within the scope of the appended claims.

1. A method for selecting a number of TV programs preferred by a viewer to be received in a given time period [b,e] beginning at time b and ending at time e, comprising the steps of:
specifying a set S including a number n≧1 preferred TV programs s numbered 1, . . . , n each having a begin time bₛ, an end time eₛ, and a viewer-preference value νₛ (301.1);
providing M≧1 tuners (303) to receive and record a TV program s of S;
constructing a directed graph G=(V, E) comprising a set of nodes V and a set of edges E having associated costs and capacities, said nodes and edges being arranged in increasing time order from a start node at time 0 to a sink node at time ∞ and for each sεS including a node pair consisting of (bₛ, eₛ) and at least one edge therebetween; and
applying a minimum-cost network flow algorithm (302.1) to the directed graph to determine a subset S′⊂S such that a pre-determined function of the viewer-preference νₛ over the subset S′ is maximized and the TV programs in S′ are received by the M≧1 tuners without conflicts during the time period [b,e].

2. The method of claim 1, wherein the specifying step further comprises the step of the viewer or a recommender specifying the set S.

3. The method according to claim 1, wherein the constructing step further comprises the steps of:
creating a timeline of zero cost edges each having capacity M, from the start node to the sink node by placing thereon the node pair for each sεS; and
creating an edge between each node pair corresponding to sεS having an associated cost determined by the viewer-preference value νₛ and capacity 1.

4. The method of claim 3, wherein the applying step further comprises the step of the pre-determined function computing the linear sum of viewer-preference νₛ over the subset S′.

5. The method of claim 4, wherein the specifying step further comprises the step of selecting sεS such that b≦bₛ<eₛ≦e.

6. The method of claim 5, wherein the specifying step further comprises the step of the viewer or a recommender specifying the set S.

7. An apparatus (300) for reception and delivery of viewer-preferred TV programs (304) during a given time period [b,e] beginning at time b and ending at time e, comprising:
a memory module (301) containing a set S of a number n≧1 of viewer-preferred TV programs numbered s=1, . . . , n each having a begin time bₛ, an end time eₛ, and a viewer preference value νₛ;
a number M≧1 of tuners (303) to receive (and record) a program s of S; and
a processor module (302) configured to execute a minimum-cost network algorithm module that accesses the memory to select a subset S′⊂S of the specified set S of programs to receive and record, such that the programs in S′ can be received by the plurality of tuners without conflicts within the time interval [b, e], and the total of the viewer preference value of the subset S′ is maximized.

8. A system (400) for scheduling a TV viewing session of programs preferred by a viewer, comprising:
a TV set (401) for viewing a programs; and
an apparatus (300) according to claim 7 for selecting and receiving a viewer's preferred TV programs and displaying on the TV (400) at least a part of the received programs during a predetermined time span [b, e] having a beginning time b and an ending time e.

9. An apparatus (300) for reception and delivery of viewer-preferred TV programs (304) during a given time period [b,e] beginning at time b and ending at time e, comprising:
a memory module (301) containing data describing a set S of a number n≧1 of viewer-preferred TV programs numbered s=1, . . . , n each having a begin time bₛ, an end time eₛ, and a viewer preference value νₛ;
a set of M≧1 tuners (303) to receive (and record) a program s of S; and
a processor module (302) configured to execute the method of claim 6 using the data describing set S contained in the memory module (301) and the set of tuners.

10. A system (400) for scheduling a TV viewing session of programs preferred by a viewer, comprising:
a TV set (401) for viewing a programs; and
an apparatus (300) according to claim 9 for selecting and receiving a viewer's preferred TV programs and displaying on the TV (400) at least a part of the received programs during a predetermined time span [b, e] having a beginning time b and an ending time e.

11. A computer program stored in a memory (301), comprising an executable module (200) to perform the method of claim 1 (302.1) and a data module (301.1) including a set S as input to the method of claim 6 comprising a number n≧1 of preferred TV programs numbered s=1, . . . , n each having a begin time bₛ, an end time eₛ, a viewer-preference value νₛ.

12. A computer program stored in a memory (301), comprising an executable module (200) to perform the method of claim 6 (302.1) and a data module (301.1) including a set S as input to the method of claim 1 comprising a number n≧1 of preferred TV programs numbered s=1, . . . , n each having a begin time bₛ, an end time eₛ, a viewer-preference value νₛ.
